(19) United States
(12) Patent Application Publication
(10) Pub. No.: US 2009/0228941 A1
(43) Pub. Date: Sep. 10, 2009

(54) Video System and a Method of Using the Video System

(75) Inventors: Sam Russell, Tinton Falls, NJ (US); Paritosh Bajpay, Edison, NJ (US); David H. Lu, Morganville, NJ (US); Shiu Y. Chong, Fair Haven, NJ (US)

Correspondence Address: AT&T Legal Department - LNAP;Attn: Patent Docketing, Room 2A- 207, One AT & T Way, Bedminster, NJ, 07921, US

(73) Assignee: AT&T INTELLECTUAL PROPERTY, LP, Reno, NV (US)

(21) Appl. No.: 12/043,003

(22) Filed: Mar. 5, 2008

(51) Int. Cl. H04N 7/173

(52) U.S. Cl. 725/107

(57) ABSTRACT

A test system can include a test controller, a source system, and a measurement system. The source system can provide a test video clip or test packetized data stream that is injected into a broadcast portion of a service provider's access network at a point similar where other broadcast content would be introduced. The measurement system can be coupled to network equipment downstream or to a capture device, which is coupled to network equipment downstream. Configurations allow for more than one source system, measurement system, or capture system to allow flexibility in implementation for a particular application. The test system can be used to detect a problem or other issue before a customer at a customer premises would experience degradation in quality of experience.

### FIELD OF THE DISCLOSURE

The present disclosure relates to video systems and methods of using the video systems.

### BACKGROUND

Digital networks can be used to transmit voice communications, video content, and data (other than voice or video). The digital networks may be managed and controlled to provide at least a minimum bandwidth and data integrity of the information transmitted over the digital network. Dropped packets are typically not a problem for browser applications, as the dropped packets can be retransmitted without a significant adverse impact. For voice communications, the dropped packet may be assumed to be silence or a bad connection. For video content such as a video clip or a movie, a substantial portion of the content may be buffered or otherwise saved prior to its display. Dropped packets from the video content can be retransmitted before a frame with the dropped packet would be seen by an end user. For data, retransmitting dropped packets during a download is typically not problematic.

### BRIEF DESCRIPTION OF THE DRAWINGS

Skilled artisans will appreciate that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 includes a block diagram illustrating an embodiment of an Internet protocol television system;

FIG. 2 includes a block diagram illustrating some of the connections between the customer premises and other portions of a network that supports the Internet protocol television system;

FIG. 3 includes an architecture that can be used to test a video system;

FIG. 4 includes an architecture that can be used with groupings of capture devices with associated measurement systems;

FIG. 5 includes a flow diagram illustrating a method of testing transmission of a test video clip over a dedicated test channel of a service provider's access network; and

FIG. 6 includes a block diagram of an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, understand that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

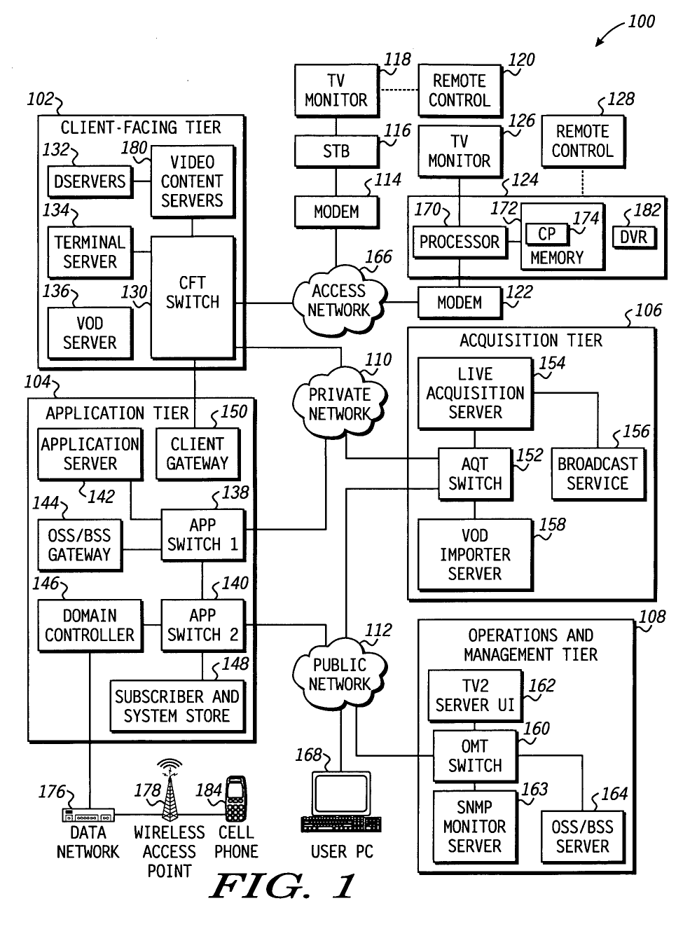

FIG. 1 includes an illustration of an Internet protocol television (“IPTV”) system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to a public network, such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an IPTV network. In an illustrative embodiment, modems, such as a first modem 114 and a second modem 122, can be coupled to the private access network 166. The client-facing tier 102 can communicate with a first representative set-top box (“STB”) device 116 via the first modem 114 and with a second representative STB device 124 via the second modem 122. The client-facing tier 102 can communicate with a large number of STBs over a wide geographic area, such as a regional area, a metropolitan area, a viewing area, or any other suitable geographic area that can be supported by networking the client-facing tier 102 to numerous STB devices. In one embodiment, the client-facing tier 102 can be coupled to the modems 114 and 122 via fiber optic cables. Alternatively, the modems 114 and 122 can be digital subscriber line (“DSL”) modems that are coupled to one or more network nodes via twisted pairs, and the client-facing tier 102 can be coupled to the network nodes via fiber-optic cables. Each STB device 116 and 124 can process data received from the private access network 166 via an IPTV software platform, such as Microsoft® TV IPTV Edition.

The first STB device 116 can be coupled to a first display device 118, such as a first television monitor, and the second STB device 124 can be coupled to a second display device 126, such as a second television monitor. Moreover, the first STB device 116 can communicate with a first remote control 120, and the second STB device can communicate with a second remote control 128. In an exemplary, non-limiting embodiment, each STB device 116 and 124 can receive data or video from the client-facing tier 102 via the private access network 166 and render or display the data or video at the display device 118 or 126 to which it is coupled. The STB devices 116 and 124 thus may include tuners that receive and decode television programming information for transmission to the display devices 118 and 126. Further, the STB devices 116 and 124 can include an STB processor 170 and an STB memory device 172 that is accessible to the STB processor. In a particular embodiment, the STB devices 116 and 124 can also communicate commands received from the remote controls 120 and 128 back to the client-facing tier 102 via the private access network 166.

In an illustrative embodiment, the client-facing tier 102 can include a client-facing tier (“CFT”) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand (“VOD”) content. The CFT switch 130 can also be coupled to a terminal server 134 that provides terminal devices, such as a game application server and other devices with a common connection point to the private network 110. In a particular embodiment, the CFT switch 130 can also be coupled to a VOD server 136.

The application tier 104 can communicate with both the private network 110 and the public network 112. In this embodiment, the application tier 104 can include a first application tier (“APP”) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the STB devices 116 and 124 via the private access network 166, so the STB devices 116 and 124 can provide functions, such as display, messaging, processing of IPTV data and VOD material. In a particular embodiment, the OSS/BSS gateway 144 includes operation systems and support (“OSS”) data, as well as billing systems and support (“BSS”) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the STB devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen STB devices, from accessing the private network 110, by denying access to these devices beyond the private access network 166.

For example, when the STB device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the STB device 116 access to IPTV content and VOD content. If the client gateway 150 cannot verify subscriber information for the STB device 116, such as because it is connected to a different twisted pair, the client gateway 150 can deny transmissions to and from the STB device 116 beyond the private access network 166.

The acquisition tier 106 includes an acquisition tier (“AQT”) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch 152 can be coupled to a VOD importer server 158 that stores television content received at the acquisition tier 106 and communicate the stored content to the client-facing tier 102 via the private network 110.

The operations and management tier 108 can include an operations and management tier (“OMT”) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (“SNMP”) monitor 163 that monitors network devices. In a particular embodiment, the OMT switch 160 can communicate with the AQT switch 152 via the public network 112.

In a particular embodiment, during operation of the IPTV system, the live acquisition server 154 can acquire television content from the broadcast service 156. The live acquisition server 154 in turn can transmit the television content to the AQT switch 152, and the AQT switch 152 can transmit the television content to the CFT switch 130 via the private network 110. Further, the television content can be encoded at the D-servers 132, and the CFT switch 130 can communicate the television content to the modems 114 and 122 via the private access network 166. The STB devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the STB device 116 or 124, the request can be transmitted over the private access network 166 to the VOD server 136 via the CFT switch 130. Upon receiving such a request, the VOD server 136 can retrieve requested VOD content and transmit the content to the STB device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (“PC”) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices, such as a cellular telephone 180.

In a particular embodiment, the STB devices can include an STB computer program 174 that is embedded within the STB memory device 172. The STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second STB device 124. For instance, in an illustrative embodiment, the account information can relate the user's account to the second STB device 124 by associating the user account with an IP address of the second STB device 124, with data relating to one or more twisted pairs connected with the second STB device 124, with data related to one or more fiber optic cables connected with the second STB device 124, with an alphanumeric identifier of the second STB device 124, with any other data that is suitable for associating second STB device 124 with a user account, or with any combination of these.

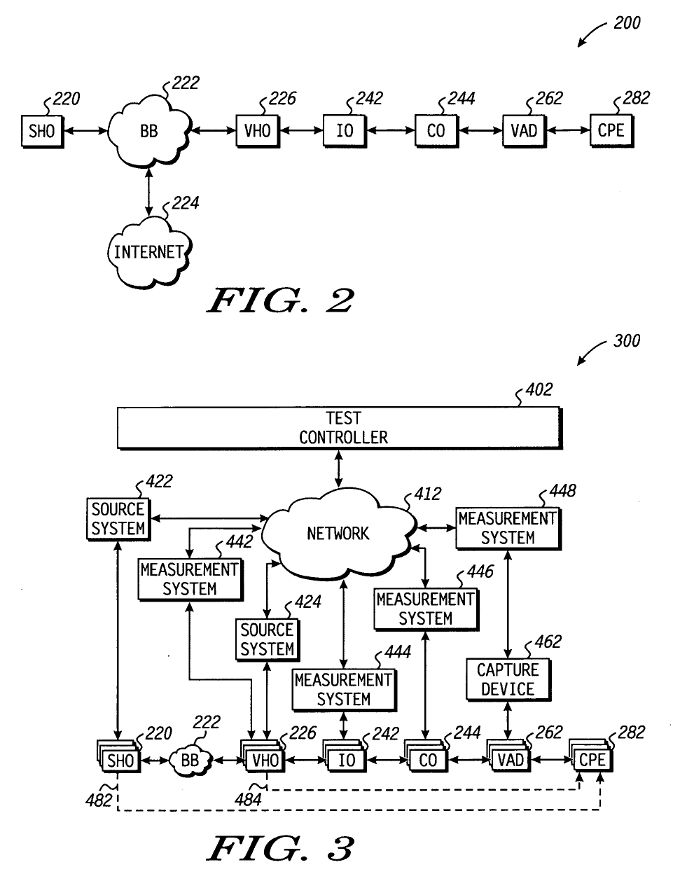

FIG. 2 includes an illustration of a portion of an exemplary network 200 that can be used to deliver digital content, such as IPTV using the IPTV system 100 in FIG. 1, to a customer. The network can include a super hub office (“SHO”) 220 that is bidirectionally coupled to an Internet protocol backbone (“BB”) 222 that is bidirectionally coupled to each of the Internet 224 and a video hub office (“VHO”) 226. In one embodiment, streaming video content provided from a national broadcaster (e.g., ABC™, CBS™, CNN™, HBO™, etc.) can be sent to and received by the SHO 220. Streaming video content from local broadcasters can be sent to and received by the VHO 226. VOD content can be received by and stored within the VHO 226. Internet access can be established via the BB 222 to the Internet 224. Such Internet access can be useful for obtaining files, making calls, requesting other content, or any combination thereof by a customer at the customer premises.

Continuing with the network 200, an intermediate office (“IO”) 242 is bi-directionally coupled to the VHO 226 and a central office (“CO”) 244. The CO 244 is bidirectionally coupled to a video access device (“VAD”) 262. The VAD 262 can be a digital subscriber line access multiplexer, a video ready access device, or the like. The video access ready device is similar to the digital subscriber line access multiplexer, but the video access ready device is particularly designed for streaming broadcast video for IPTV. The VAD 262 is bidirectionally coupled to customer premises equipment (“CPE”) 282.

After reading this specification, skilled artisans will appreciate that many different network configurations are possible. For example, VOD content may be accessed by a customer via the Internet 224 or the SHO 220, instead of the VHO 226. No intermediate office or a plurality of intermediate offices similar to the IO 242 may be used. More than one SHO or VHO may also be used. Thus, the particular implementation of a network used to provide services to a customer is variable and can be tailored to the needs or desires of a network operator. Therefore, the network 200 in FIG. 2 is merely for purposes of illustration and is not to be construed as limiting the scope of the present invention.

FIG. 3 includes an illustration of an architecture that can be used to automatically test a packet-switched network of a service provider, wherein the packet-switched network is operable to stream packets of video broadcasts in real time or near real time. An IPTV network is an example of such a network. In FIG. 3, an exemplary testing system 300 can be used to inject packets corresponding to one or more test video clips into the network to simulate a broadcast transmission, however, the test video clips can be broadcast over a dedicated test channel, rather than an entertainment broadcast channel. As used herein, an entertainment broadcast channel is a channel of the network over which end users, such as customers of the service provider, receive video content for their own use and enjoyment. The entertainment broadcast channels can correspond to the national or local broadcasters. The dedicated test channel is a channel of the network over which test packetized data streams corresponding to test video clips or other test video content are principally transmitted. In a particular embodiment, the dedicated test channel only transmits test packetized data streams and test video content, and in a more particular embodiment, test packetized data streams are normally transmitted at substantially all times. The dedicated test channel may not be operational during abnormal times, such as a power outage, service or maintenance, or another event.

The test video clip can be in a Motion Pictures Expert Group (“MPEG”) standard, such as MPEG-2, MPEG-4, or another digital format. In a particular embodiment, test video clip can include I-Frames, P-Frames, and B-Frames. Referring briefly to FIG. 3, the test video clip can be stored at or accessible to the test controller 402, the source system 422 or 424, the measurement system 442, 444, 446, or 448, or any combination thereof. When transmitted, the source system 422 or 424 or network equipment at the SHO 220 or VHO 226 can convert the test video clip into a test packetized data stream for transmission over the service provider's access network, such as the private access network 116 as illustrated in FIG. 1. The test packetized data stream can be transmitted over the dedicated test channel at a regular or other interval. The test video clip can simulate conditions that could occur, such as using all possible colors, text, audio, high-speed motion, slow-speed motion, fading, changing from motion to still pictures, synchronization, another suitable condition, or any combination thereof.

The system 300 includes a test controller 402 that is bidirectionally coupled to a network 412. The test controller 402 can be operated to create topology information, such as source and measurement systems, which are described in more detail later in this specification. The test controller 402 can also be operable to establish and maintain connectivity to the source and measurement systems, set broadcast schedules to be used by the source systems, set polling intervals on the measurement systems at regular intervals (e.g., once a day) for measurement data, and poll any measurement system for status and measurement results, correlate the measurement data for providing reports, generate proactive real-time reports, generate predictive reports such as a fault trend report, detect progressive degradation of service/location automatically, provide other information regarding alarms, alerts, or status, or any combination thereof. The test controller 402 can be in the form of a computer system, such as a server.

In an embodiment, the network 412 can be a public network or a private network, such as private network 110 as illustrated in FIG. 1. The network 412 is bidirectionally coupled to a source system 422. The source system 422 can be accessed and controlled by the test controller 402. The source system 422 can be operable to act as the source for the test video clip, maintain connectivity to broadcast network equipment in the SHO 220, send the test video clip to the SHO 220, provide another suitable function, associate the test video clip with the dedicated test channel, or any combination thereof. The source system 422 can be in the form of a computer system, such as a server.

As illustrated in the embodiment in FIG. 3, the source system 422 is bidirectionally coupled to the SHO 220. More particularly, the source system 422 can be bidirectionally coupled to broadcast network equipment, such as transmission equipment (e.g., a router). The test video clip may be converted to a test packetized data stream by the source system 422 or network equipment at the SHO 220. The network equipment can transmit the test video clip as a test packetized data stream along a broadcast transmission path 482 over the dedicated test channel, wherein the broadcast transmission path 482 can also be used to transmit other packets of other packetized data streams over the entertainment broadcast channels. Thus, a data stream may or may not be a continuous uninterrupted series of packets. In a particular embodiment, packets that are part of the test video clip can be interleaved with packets for entertainment broadcast channels. At the source system 422, the packets can be associated with an identifier corresponding to the dedicated test channel. For example, an identifier within a header or other part of the packet can be assigned a value corresponding to the dedicated test channel.

In a particular embodiment, the test system 420 can be used to control when the source system 422 is to provide the test video clips or test packetized data streams to the SHO 220 for transmission over the dedicated test channel. For example, the test packetized data streams corresponding to the test video clips may be transmitted over the dedicated test channel at substantially all times. In another embodiment, any particular test packetized data streams may be transmitted at a regularly scheduled interval or may be transmitted on an ad-hoc or other irregular basis. After reading this specification, skilled artisans will be able to determine how frequently particular test packetized data streams are to be transmitted over the dedicated test channel.

In another embodiment, another source system 424 can be used. The other source system 424 can be bidirectionally coupled to the network 412. The other source system 424 may perform any of the functions and include the features as described with respect to the source system 422. As illustrated in the embodiment in FIG. 3, the other source system 424 can be operable to act as the source for the test video clip or test packetized data streams, maintain connectivity to broadcast network equipment in the VHO 226, send the test video clip as to the VHO 226, provide another suitable function, associate the test video clip with the dedicated test channel, or any combination thereof. The other source system 424 can be in the form of a computer system, such as a server.

In FIG. 3, the source system 424 is bidirectionally coupled to the VHO 220. More particularly, the other source system 424 can be bidirectionally coupled to broadcast network equipment, such as transmission equipment (e.g., a router). The broadcast network equipment can transmit the test video clip as a test packetized data stream along a broadcast transmission path 484 over the dedicated test channel, wherein the broadcast transmission path 484 can also be used to transmit other packets of other packetized data streams over the entertainment broadcast channels.

The source system 422 can be used in a manner to simulate transmissions that video content from the national broadcasters would be transmitted using the service provider's access network, and the other source system 424 can be used in a manner to simulate transmissions that video content from the local broadcasters would be transmitted using the service provider's access network. The broadcast transmission path 482 can be the longest normal broadcast transmission path within the service provider's access network to the CPE 282, and the broadcast transmission path 484 can be an intermediate broadcast transmission path within the service provider's access network to the CPE 282. In still another embodiment, another source system (not illustrated) can be used and be coupled to a point between the VHO 226 and the CPE 282. In yet another embodiment, the source system 422 may be coupled to the VHO 226, IO 242, the CO 244, or the VAD 262 in place of or in addition to being coupled to the SHO 226. Thus, the other source system 424 is not needed but can be used if desired.

When the source system 422 is coupled to the SHO 220, the test packetized data stream corresponding to the test clip is transmitted from the SHO 220. The network equipment at VHO 226 and other points downstream (going towards CPE 282) can transmit, route, or perform other functions such that the test packetized data stream is received by the measurement systems 442, 444, or 446 or the capture device 462, as illustrated in FIG. 3. The measurement system 442 is bidirectionally coupled to the network 412 and the VHO 226, the measurement system 444 is bidirectionally coupled to the network 412 and the IO 242, and the measurement system 446 is bidirectionally coupled to the network 412 and the CO 244. The capture device 462 is bidirectionally coupled to the VAD 262 and a measurement system 448, which is bidirectionally coupled to the network 412.

Each of the measurement systems 442, 444, 446, and 448 can be accessed and controlled by the test controller 402. Each of the measurement systems 442, 444, 446, and 448 can be operable to act as a measurement collector and data aggregator for the dedicated test channel, receive and test packetized data streams that have been broadcast over the dedicated test channel at its particular point along the broadcast transmission path, performing another suitable function, or any combination thereof. Each of the measurement systems 442, 444, 446, and 448 can be in the form of a computer system, such as a server.

In a particular embodiment, a router or other similar network equipment along the broadcast transmission path can parse packets within the test packetized data stream and determine that such packets are being transmitted over the dedicated test channel. The router will transmit the packets downstream, and if a measurement system or capture device is coupled to the router, the router will also transmit the packets to the measurement system or capture device.

At the measurement systems 442, 444, 446, and 448, one or more tests can be performed. In an embodiment, after receiving packets for the test packetized data stream, the measurement system can generate the test video clip from the packets. The measurement system can compare the received test video clip to a previously stored test video clip in the measurement system. In a particular embodiment, the test controller 402 can transmit the test video clip to the measurement system via the network 412, and the test video clip from the test controller 402 can be used instead of the stored test video clip. The test controller 402 can provide specification, control or other limits to the measurement systems to be used in conjunction with the tests. The limits can be for alarms, alerts, or any combination thereof. The measurement systems can automatically generate and send a notice regarding an alarm or alert to a trouble ticketing system or other similar system when a test result is beyond a limit. The measurement system can also be polled at predetermined or other intervals by the test controller 402 to collect measured parameters or other test results.

The measurement system may be operable to perform other functions. In another embodiment, tests may be performed on the test packetized data stream or test video clip to determine changes that may or may not be a function of time. For example, a particular test video clip can be transmitted as a packetized data stream on a reoccurring basis (e.g., hourly, daily, etc.). A difference in any parameter, whether it is the test video clip itself or data collected as the test packetized data steam was being broadcast or received (e.g., transmission rate, dropped packets, etc.) between any two transmissions, can be determined. The difference can be expressed as a magnitude (e.g., an absolute value), a magnitude and sign (e.g., + or −), or as a relative value (e.g., percentage change) with or without a sign. In this manner, the service provider may gain information if a portion of the service provider's access network is trending in a direction before an alarm or alert is reached. In still another embodiment, more than one difference can be collected, and changes between the differences (similar to a second derivative) can be obtained. In still a further embodiment, readings can be integrated over time. Thus, a service provider can develop relatively simple or complex schemes (e.g., proportional, derivative, or integral control) for monitoring and potentially controlling a broadcast portion of the service provider's access network.

The capture device 462 can be operable to capture the test packetized data stream or other test video content received over the dedicated test channel and send the captured test packetized data stream or other test video content to a corresponding measurement system, such as the measurement system 448. The capture device 462 can be relatively inexpensive, small, environmentally insensitive, or any combination thereof. In a particular embodiment, each VAD 262 will have a corresponding capture device 462. The VAD 262 and corresponding capture device 462 can be co-located within the same housing, where the housing is exposed to an outdoor ambient. Thus, more sensitive measuring equipment, such as the measurement system 448, can be located within a structure, such as an office, remote to the housing and maintained similar to office computer systems.

Many other configurations can be used and not depart from the concepts as described herein. As illustrated in FIG. 3, the source system 422 can be coupled to network equipment at more than one SHO 220, the other source system 424 can be coupled to network equipment at more than one VHO 226, or any combination thereof. Similarly, the measurement system 442 can be coupled to network equipment at more than one VHO 226, the measurement system 444 can be coupled to network equipment at more than one IO 242, the measurement system 446 can be coupled to network equipment at more than one CO 244, or any combination thereof.

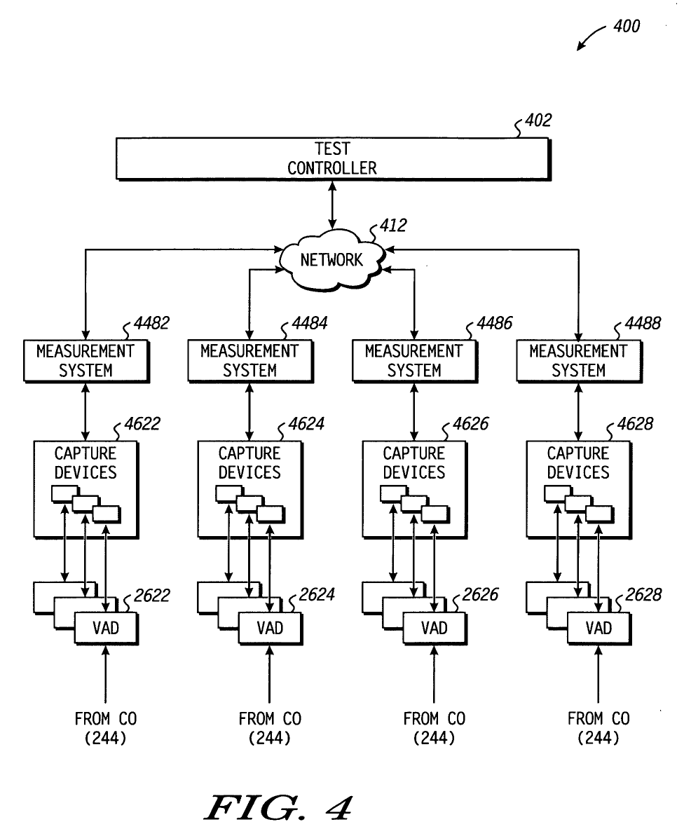

In another embodiment, a clustered configuration can be used for capture devices and measurement systems, as illustrated in FIG. 4. The network 412 can be bidirectionally coupled to measurement systems 4482, 4484, 4486, and 4488. The measurement systems 4482, 4484, 4486, and 4488 can be bidirectionally coupled to sets of capture devices 4622, 4624, 4626, and 4628, respectively, and the sets of capture devices 4622, 4624, 4626, and 4628 can be bidirectionally coupled to sets of VADs 2622, 2624, 2626, and 2628, respectively. The measurement systems 4482, 4484, 4486, and 4488, sets of capture devices 4622, 4624, 4626, and 4628, and the sets of VADs 2622, 2624, 2626, and 2628 can perform the functions as previously described with respect to the measurement systems 448, the capture device 462, and the VAD 262.

In a particular embodiment, each capture device within the sets of capture devices is coupled to a single VAD within the sets of VADs, and a plurality of capture devices are coupled to a single measurement system. The test controller 402 controls the measurement systems 4482, 4484, 4486, and 4488, and the measurement systems 4482, 4484, 4486, and 4488 control their corresponding capture devices.

In still another embodiment (not illustrated), a capture device may be coupled to a measurement system and network equipment at an office along a broadcast transmission path. For example, a capture device may be coupled to the measurement system 446 and network equipment within the CO 244.

More or fewer source or measurement systems may be used. For example, each office may have its own source system, similar to source system 422. Thus, a source system may be coupled to network equipment at the IO 242 or the CO 244. In another embodiment, a single source system may be used for the service provider's access network. The single source system may be configured such that it is operable to inject a test packetized data stream at nearly any point along a broadcast transmission path. In still another embodiment, the same measurement system may be used for the VHO 224 and the IO 242. In a further embodiment, more than one measurement system can be used for the CO 244. In still a further embodiment, a capture device, a measurement system, or both may be temporarily or permanently coupled to the CPE 282. For example, the capture device or measurement system may be connected to a network interface device at the customer premises when performing a service call, to receive video content as broadcasted over the dedicated test channel at the customer premises.

The source and measurement systems can be located at their corresponding offices at which such systems connect to the network equipment. For example, the source system 422 can be at the same site as the SHO 220, and the measurement system 442 can be at the same site as the VHO 226. In another embodiment, any of the source and measurement systems may be located at the same site as the test controller 402. Measurement systems for different parts of the broadcast network may be located at the same site. For example, a measurement system for a particular CO 244 and a measurement system for VADs 262 served by that particular CO 244 may be located at the particular CO 244.

After reading this specification, skilled artisans will appreciate that many other configurations and location strategies may be used to service the needs or desires for their particular application. The test system 400 can be separate from and used to provide information to a management system used to manage the service provider's access network. In a particular embodiment, each of the test controller 402, the source systems 422 and 424, the measurement systems 442, 444, 446, and 448, and the capture device 462 (collectively, the “Test Equipment”) are located outside the broadcast transmission path. Video or other content that is provided to the CPE 282 does not pass through the Test Equipment. Thus, the Test Equipment can be added, removed, modified, be in use, not be in use, or any combination thereof without any significant affect on the CPE 282. Other than viewing the dedicated test channel, a customer using the CPE 282 may not realize that the Test Equipment is or is not present or whether the Test Equipment is or is not operational. Therefore, the customer can enjoy video content received over one or more entertainment broadcast channels, while the Test Equipment is ensuring a relatively high level of quality of experience by the customer.

In another embodiment, the test system 400 or a portion thereof (e.g., the test controller 402) may be part of the management system. Broadcast data streams, including the test packetized data streams using the dedicated test channel, do not pass through the capture devices or the measurement systems on the way to the CPE 282. Thus, the test system 400 can be used without significantly interfering with reception of video content over entertainment broadcast channels or the dedicated test channel at the CPE 282.

The test packetized data streams can be pushed to or pulled by Test Equipment. In an embodiment, the capture device 462 may push a test packetized data stream to the measurement system 448 without any corresponding action by the measurement system 448. In another embodiment, the capture device 462 may transmit a test packetized data stream to the measurement system 448 only after the capture device 462 receives a request, is polled, or is acted upon by the measurement system 448. Similarly, the information generated by the measurement systems 442, 444, 446, and 448 may be pushed to or pulled by the test controller 402. After reading this specification, skilled artisans will be able to design a test system that meets the needs or desires, given a particular application.

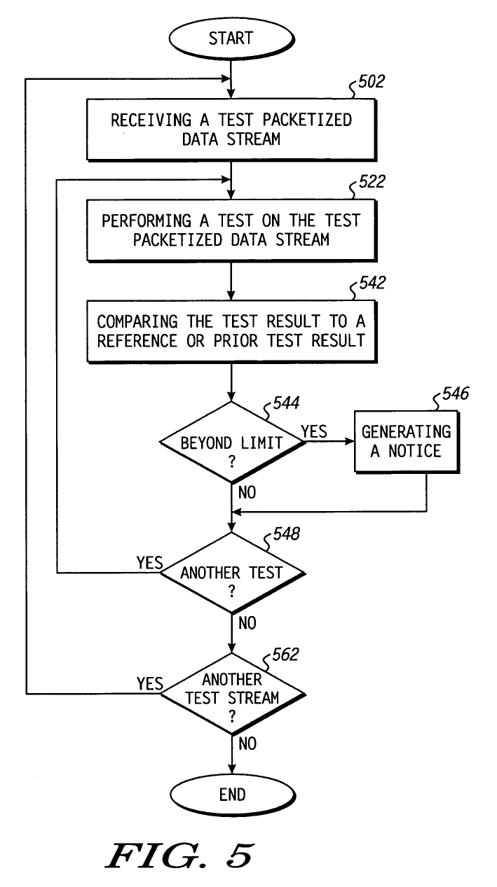

FIG. 5 includes a flow diagram of a method of using the test system. In one embodiment, all operations described with respect to FIG. 5 may be performed by a measurement system. In another embodiment, an operation or a portion of an operation may be performed by a different device within the test system. The method can include receiving a test packetized data stream, at block 502. The test packetized data stream can be received by any of the measurement systems or be received and forwarded by a capture device to its corresponding measurement system.

The method can also include performing a test on the test packetized data stream, at block 522. Many different tests can be performed while the test packetized data stream is being received or thereafter. A test can include monitoring a performance parameter or other characteristic of an incoming stream. Thus, the term test is to be construed broadly.

In an embodiment, a test packetized data stream corresponding to the test video clip is transmitted and received by the measurement system. The measurement system can process the received stream to generate a transmitted video clip, which can be used as described with a comparison operation described below. Another test may also be performed. For example, the rate at which packets are received may be monitored. In another example, the number of times one or more missing packets are requested by the measurement system or retransmitted by the network equipment along the broadcast transmission path may be measured. In still another embodiment, another parameter may be monitored or a different test may be performed. The information acquired by any of the tests can be used to generate a test result.

The method can further include comparing the test result to a reference or prior test result, at block 542. In one embodiment, the test video clip may have previously been sent from the test controller 402 and received by and stored at a measurement system, such as the measurement system 442. The test video clip that is locally stored on the measurement system will be referred to as the stored test video clip. The transmitted test video clip can be treated as a test result and the stored test video clip can be treated as a reference. In this particular embodiment, the comparison can be between the transmitted and stored test video clips.

In another embodiment, other data can be generated from a comparison operation. In one embodiment, a test video clip, or a portion thereof, can be retransmitted on a regular basis (e.g., hourly, daily, etc.) or irregular basis (e.g., after equipment or software upgrade or replacement, other service or maintenance, after a power outage, or the like). A comparison can include comparing a current reception rate to a prior reception rate to obtain a reception rate difference. In another embodiment, the number of retransmitted packets from a current test packetized data stream can be compared to the number of retransmitted packets from a previous transmission of the same test packetized data stream to obtain a retransmission difference. Each of the reception rate difference and retransmission difference is similar to a first derivative. Either or both differences may be useful to determine if the service provider's network equipment is drifting or trending in a particular direction. If more data is available, a change between differences can be obtained and would be similar to a second derivative. In still another embodiment, test results can be integrated over time. The significance of the first derivative, second derivative, and integral value will be discussed in more detail later in this specification. For the purposes of this specification, the information corresponding to a first derivative, second derivative, or integral value are considered a particular type of test result.

The form of the test results can be varied based on the data collected or the needs or desires of the service provider. The test result can be a measured parameter. In another embodiment, the test result can be a difference or an absolute value of the difference. In still another embodiment, the test result can be normalized or a relative term (e.g., a percentage).

In a particular embodiment, the comparison operation is not required and may be omitted or deleted if needed or desired.

The method can also include determining whether a test result or information derived from a test result is beyond a limit, at decision tree 544. Theoretically, the stored and transmitted test video clips are identical. However, if there is a significant amount of noise or other transmission problem, the stored and transmitted test video clips will differ. If the difference between the two test video clips is too great, the difference is beyond the limit. In other embodiments, other test results, such as rates, differences, changes in differences, integral values, and the like, can be used.

If the test result or information derived from the test result is beyond the limit (“Yes” branch from decision tree 544), the measurement system can generate a notice. The notice can include an alarm, an alert, or other warning, a test result or information derived from a test result, other suitable information that may be useful in diagnosing or performing a corrective measure, or any combination thereof. The notice can be sent from the measurement system and received by the test controller 402. The test controller 402 may forward the notice to the broadcast management system, an administrator, another suitable recipient, or any combination thereof. The broadcast management system, administrator, or other recipient can take appropriate action based on information within the notice.

If the test result or information derived from the test result is not beyond the limit (“No” branch from decision tree 544) or after generating the notice at block 546, a determination can be made whether another test is to performed on the test packetized data stream, at decision tree 548. If another test is to be performed (“Yes” branch from decision tree 548), the method can be iterated starting at block 522. Otherwise (“No” branch from decision tree 548), a determination is made whether another test packetized data stream is to be received, at decision tree 562. If another test packetized data stream is to be performed (“Yes” branch from decision tree 562), the method can be iterated starting at block 502. Otherwise (“No” branch from decision tree 548), the method may end.

The information corresponding to first derivatives, second derivatives, and integral values can be useful with the method, even if thresholds are not exceeded. The information corresponding to the first derivative can be used to determine how quickly and in which direction the broadcast network is trending. A notice may or may not be generated on the basis of the first derivative information. In another embodiment, information from the second derivative may be used to determine if the notice should be generated or if action should be taken by the service provider. For example, if a second derivative is negative, the system may be trending away from its original or prior state; however, at a slower rate. No correction action may be performed, as a correction may cause the system to become more unstable than if the system were allowed to continue without any corrective action.

The integral value can be useful in determining a cumulative error or other effect over time. If the information corresponding to the first derivative is relatively low, and the second derivative is close to zero, the cumulative effect may still be significant. For example, the rate at which packets are received may be declining at 0.2% per hour. While the rate of decline by itself for any one-hour time interval may not be significant, over a 12-hour period, the rate may have declined by 2.4%. Even if the rate of receiving packets is acceptable and the hourly rate of change in the rate is acceptable, the integral value can provide information indicating that corrective action should be taken.

The derivative and integral control can be used as an alternative or in conjunction with other control methods. The comparison between transmitted and stored test video clips can still be performed. The derivative and integral control methods can be used to indicate when corrective action should or should not be taken and may indicate that corrective action should be taken sooner as compared to a simple test video clip comparison.

The system and components (e.g., the test controller 402, the source system 422, the measurement system 442, etc.) described herein can be implemented using a general computing system, and the methods described can be carried out by the general computing system that may be located within the network.

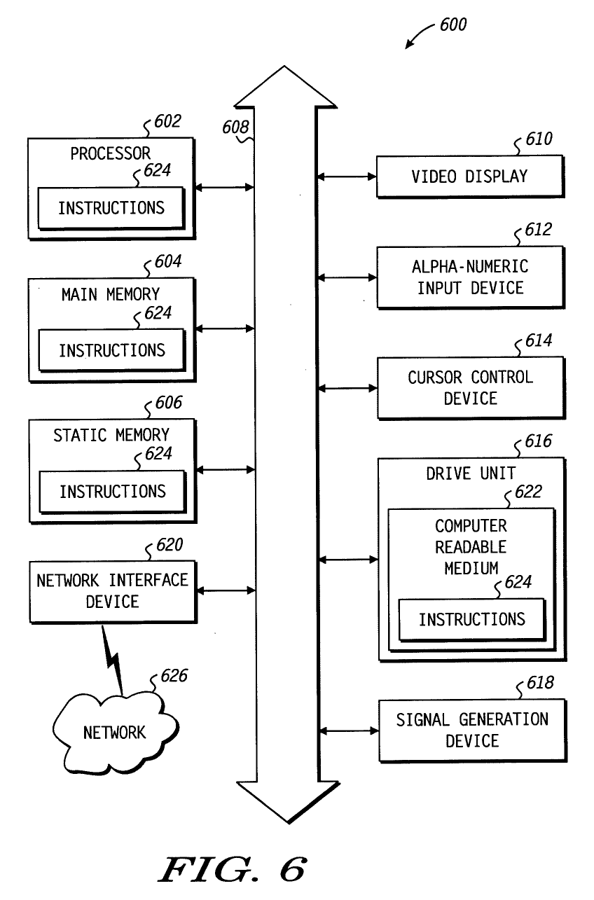

FIG. 6 includes an illustrative embodiment of a general computer system 600. The computer system 600 can include a set of instructions that can be executed to cause the computer system 600 to perform any one or more of the methods or computer based functions disclosed herein. The computer system 600 may operate as a standalone device or may be connected, such as by using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a desktop PC, a laptop PC, an STB, a personal digital assistant (“PDA”), a mobile device, a palmtop computer, a laptop computer, a desktop computer, a communications device, a wireless telephone, a wireline telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, such as a central processing unit (“CPU”), a graphics processing unit (“GPU”), or both. Moreover, the computer system 600 can include a main memory 604 and a static memory 606 that can communicate with each other via a bus 608. As shown, the computer system 600 may further include a video display unit 610, such as a liquid crystal display (“LCD”), an organic light emitting diode (“OLED”), a flat panel display, a solid state display, or a cathode ray tube (“CRT”). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620 to communicate with a network 626. In a particular embodiment, the disk drive unit 616 may include a computer-readable medium 622 in which one or more sets of instructions 624, such as software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

Embodiments described herein can be used to allow automatic testing of a video system. Because a test video clip can be transmitted as a test packetized data stream over a dedicated test channel, similar to broadcast video content received over an entertainment broadcast channel, the testing more closely replicates the conditions that can affect a customer's quality of experience at the CPE 262. Measurement systems can be placed at strategic points to detect more precisely where problems are first experience within the broadcast portion of the service provider's access network. Corrective actions can be taken before a customer detects a significant degradation in the customer's quality of experience at the CPE 282. In another embodiment, diagnosing and isolating a cause of a problem may occur more quickly because the test controller 402 can obtain information from the measurement systems in real time.

The system can also act proactively. The information can be examined for trends, cumulative effects, or other patterns to reduce the likelihood that a relatively minor issue does not become a problem. The test system can process the information and determine whether or not further action should be taken and can work in conjunction with the system that controls the broadcast portion of the service provider's access network to make adjustments or intentionally not make adjustments.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a video system can be used in conjunction with a packet-switched network operable to transmit video content to end-user equipment. The video system can also include a first source system coupled to first network equipment at a first point where broadcast video content would normally be introduced into the packet-switched network, wherein the first source system is operable to provide a first test packetized video data stream to the first network equipment. The video system can also include a first measurement system coupled to second network equipment at a second point along a broadcast transmission path between the first transmission equipment and the end-user equipment, wherein the first measurement system is operable to generate a first measurement associated with the first test packetized video data stream as received from the second network equipment. The video system can further include a test controller coupled to the first source and first measurement systems, wherein the test controller is operable to control the first source system and to receive information regarding the first test packetized video data stream from the first measurement system.

In an embodiment of the first aspect, the video system further includes a second measurement system coupled to third network equipment at a third point along the broadcast transmission path between the second transmission equipment and the end-user equipment, wherein the second measurement system is operable to generate a second measurement associated with the first test packetized video data stream as received from the third network equipment. In another embodiment, the video system further includes a second source system coupled to third network equipment at a third point where different broadcast video content would normally be introduced into the packet-switched network, wherein the second source system is operable to provide a second test packetized video data stream to the third network equipment, and wherein the first and third points are at different sites. In still another embodiment, the first point is at a super head office or a video head office.

In a further embodiment of the first aspect, the video system further includes a capture device coupled to third network equipment at a third point along the broadcast transmission path between the first transmission equipment and the end-user equipment, wherein the capture device is operable to receive the first test packetized video data stream from the third network equipment. The video system still further includes a second measurement system coupled to the capture device, wherein the second measurement system is operable to generate a second measurement associated with the first test packetized video data stream as received from the capture device, and wherein the test controller is coupled to the second measurement system and operable to receive information regarding the first test packetized video data stream from the second measurement system. In a particular embodiment, the third network equipment includes a video access device, wherein the capture device is physically separate from the video access device, and wherein the capture device and the video access device are disposed within a housing that is exposed to an outdoor ambient. In a more particular embodiment, the second measurement system is located at a site remote to the housing. In another more particular embodiment, another capture device does not lie between the second network equipment and the first measurement system.

In a second aspect, a video system can be used in conjunction with a packet-switched network operable to transmit video content to first end-user equipment via a broadcast transmission path. The video system can also include a first capture device located outside the broadcast transmission path and operable to receive a first test packetized data stream from network equipment at a first intermediate point between a first injection point for the first test packetized data stream and the first end-user equipment. The video system can further include a first measurement system located outside the broadcast transmission path and coupled to the first capture device, wherein the first measurement system is operable to access the first test packetized video data stream from the first capture device and generate a first measurement associated with the first test packetized video data stream.

In an embodiment of the second aspect, the video system further includes a second capture device operable to receive a second test packetized data stream from the network equipment at a second intermediate point between a second injection point for the second test packetized data stream and second end-user equipment, wherein the first measurement system is operable to access the second test packetized video data stream from the second capture device and generate a second measurement associated with the second test packetized video data stream. In a particular embodiment, the first and second capture devices are located in different offices, or the first and second capture devices are coupled to different video access devices, wherein the different video access devices are remotely located with respect to each other.

In another embodiment of the second aspect, the video system further includes a second capture device operable to receive a second test packetized data stream from the network equipment at a second intermediate point between a second injection point for the second test packetized data stream and second end-user equipment. The video system also includes a third capture device operable to receive a third test packetized data stream from the network equipment at a third intermediate point between a third injection point for the third test packetized data stream and third end-user equipment. The video system further includes a second measurement system located outside the broadcast transmission path and coupled to the second and third capture devices, wherein the second measurement system is operable to access the second test packetized video data stream from the second capture device and the third test packetized video data stream from the third capture device, wherein the second measurement system is different from the first measurement system. In a particular embodiment, the first, second, and third capture devices are different capture devices, and the first, second, and third injection points are a same injection point.

In a third aspect, a video system can be used in conjunction with a packet-switched network operable to transmit video content to end-user equipment. The video system can include first equipment operable to associate a first packetized video data stream with an entertainment broadcast channel, second equipment operable to transmit the first packetized video data stream over the entertainment broadcast channel, third equipment operable to associate a second packetized video data stream with a dedicated test channel, and fourth equipment operable to transmit the second packetized video data stream over the dedicated test channel.

In an embodiment of the third aspect, the packet-switched network is normally operable to transmit test packetized video data streams over the dedicated test channel at substantially all times. In another embodiment, the packet-switched network is configured such that only test packetized video data streams are transmitted over the dedicated test channel. In still another embodiment, the packet-switched network is operable to transmit the second packetized video data stream to the end-user equipment. In a further embodiment, wherein the second and fourth equipment are located within a same office.

In a fourth aspect, a method of testing can be performed on a video system used in conjunction with a packet-switched network. The method can include receiving a packetized video data stream at a first site along a transmission path of the packet-switched network during a first time period, and performing a test on the packetized video data stream received during a first time period to generate a first test result. The method can also include receiving the packetized video data stream at the first site along the transmission path during a second time period that is after the first time period, and performing the test on the packetized video data stream received during the second time period to generate a second test result, wherein performing a test on the packetized video data stream received during a first time period to generate a first test result and performing the test on the packetized video data stream received during the second time period to generate a second test result are performed using a same test equipment. The method can further include comparing the first and second test results to generate a first difference.

In an embodiment of the fourth aspect, the method further includes generating a notice when the first difference is beyond a threshold limit. In another embodiment, the method further includes receiving the packetized video data stream at the first site along the transmission path during a third time period that is after the first and second time periods, performing the test on the packetized video data stream received during the third time period to generate a third test result, and comparing the second and third test results to generate a second difference. In a particular embodiment, the method further includes generating a notice when a change between the first and second differences is beyond a threshold limit.

In a further embodiment of the fourth aspect, the method further includes receiving the packetized video data stream at the first site along the transmission path during a third time period that is after the first and second time periods, performing the test on the packetized video data stream received during the third time period to generate a third test result, and integrating the first, second, and third test results over time to generate an integral value. In a particular embodiment, the method further includes generating a notice when integral value is beyond a threshold limit.

A processor readable medium can include code. The code can include instructions for a processor to carry out any part or all of the methods described herein.

Note that not all of the activities described above in the general description or the examples are required, that a portion of a specific activity may not be required, and that one or more further activities may be performed in addition to those described. Still further, the order in which activities are listed are not necessarily the order in which they are performed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. In a packet-switched network operable to transmit video content to end-user equipment, a video system comprising:
a first source system coupled to first network equipment at a first point where broadcast video content would normally be introduced into the packet-switched network, wherein the first source system is operable to provide a first test packetized video data stream to the first network equipment;
a first measurement system coupled to second network equipment at a second point along a broadcast transmission path between the first transmission equipment and the end-user equipment, wherein the first measurement system is operable to generate a first measurement associated with the first test packetized video data stream as received from the second network equipment; and
a test controller coupled to the first source and first measurement systems, wherein the test controller is operable to control the first source system and to receive information regarding the first test packetized video data stream from the first measurement system.

2. The video system of claim 1 further comprising a second measurement system coupled to third network equipment at a third point along the broadcast transmission path between the second transmission equipment and the end-user equipment, wherein the second measurement system is operable to generate a second measurement associated with the first test packetized video data stream as received from the third network equipment.

3. The video system of claim 1, further comprising a second source system coupled to third network equipment at a third point where different broadcast video content would normally be introduced into the packet-switched network, wherein the second source system is operable to provide a second test packetized video data stream to the third network equipment, and wherein the first and third points are at different sites.

4. The video system of claim 1, wherein the first point is at a super head office or a video head office.

5. The video system of claim 1, further comprising:
a capture device coupled to third network equipment at a third point along the broadcast transmission path between the first transmission equipment and the end-user equipment, wherein the capture device is operable to receive the first test packetized video data stream from the third network equipment; and
a second measurement system coupled to the capture device, wherein the second measurement system is operable to generate a second measurement associated with the first test packetized video data stream as received from the capture device, and wherein the test controller is coupled to the second measurement system and operable to receive information regarding the first test packetized video data stream from the second measurement system.

6. The video system of claim 5, wherein the third network equipment includes a video access device, wherein the capture device is physically separate from the video access device, and wherein the capture device and the video access device are disposed within a housing that is exposed to an outdoor ambient.

7. The video system of claim 6, wherein the second measurement system is located at a site remote to the housing.

8. The video system of claim 6, wherein another capture device does not lie between the second network equipment and the first measurement system.

9. In a packet-switched network operable to transmit video content to first end-user equipment via a broadcast transmission path, a video system comprising:
a first capture device located outside the broadcast transmission path and operable to receive a first test packetized data stream from network equipment at a first intermediate point between a first injection point for the first test packetized data stream and the first end-user equipment; and
a first measurement system located outside the broadcast transmission path and coupled to the first capture device, wherein the first measurement system is operable to access the first test packetized video data stream from the first capture device and generate a first measurement associated with the first test packetized video data stream.

10. The video system of claim 9, further comprising a second capture device operable to receive a second test packetized data stream from the network equipment at a second intermediate point between a second injection point for the second test packetized data stream and second end-user equipment, wherein the first measurement system is operable to access the second test packetized video data stream from the second capture device and generate a second measurement associated with the second test packetized video data stream.

11. The video system of claim 10, wherein:
the first and second capture devices are located in different offices; or
the first and second capture devices are coupled to different video access devices, wherein the different video access devices are remotely located with respect to each other.

12. The video system of claim 9, further comprising:
a second capture device operable to receive a second test packetized data stream from the network equipment at a second intermediate point between a second injection point for the second test packetized data stream and second end-user equipment;
a third capture device operable to receive a third test packetized data stream from the network equipment at a third intermediate point between a third injection point for the third test packetized data stream and third end-user equipment; and
a second measurement system located outside the broadcast transmission path and coupled to the second and third capture devices, wherein the second measurement system is operable to access the second test packetized video data stream from the second capture device and the third test packetized video data stream from the third capture device, wherein the second measurement system is different from the first measurement system.

13. The video system of claim 12, wherein:
the first, second, and third capture devices are different capture devices; and
the first, second, and third injection points are a same injection point.

14. In a packet-switched network operable to transmit video content to end-user equipment, a video system comprising:
first equipment operable to associate a first packetized video data stream with an entertainment broadcast channel;
second equipment operable to transmit the first packetized video data stream over the entertainment broadcast channel;
third equipment operable to associate a second packetized video data stream with a dedicated test channel; and
fourth equipment operable to transmit the second packetized video data stream over the dedicated test channel.

15. The video system of claim 14, wherein the packet-switched network is normally operable to transmit test packetized video data streams over the dedicated test channel at substantially all times.

16. The video system of claim 14, wherein the packet-switched network is configured such that only test packetized video data streams are transmitted over the dedicated test channel.

17. The video system of claim 14, wherein the packet-switched network is operable to transmit the second packetized video data stream to the end-user equipment.

18. The video system of claim 14, wherein the second and fourth equipment are located within a same office.

19. A method of testing a video system used in conjunction with a packet-switched network, the method comprising:
receiving a packetized video data stream at a first site along a transmission path of the packet-switched network during a first time period;
performing a test on the packetized video data stream received during a first time period to generate a first test result;
receiving the packetized video data stream at the first site along the transmission path during a second time period that is after the first time period;
performing the test on the packetized video data stream received during the second time period to generate a second test result, wherein performing a test on the packetized video data stream received during a first time period to generate a first test result and performing the test on the packetized video data stream received during the second time period to generate a second test result are performed using a same test equipment; and
comparing the first and second test results to generate a first difference.

20. The method of claim 19, further comprising generating a notice when the first difference is beyond a threshold limit.

21. The method of claim 19, further comprising:
receiving the packetized video data stream at the first site along the transmission path during a third time period that is after the first and second time periods;
performing the test on the packetized video data stream received during the third time period to generate a third test result; and
comparing the second and third test results to generate a second difference.

22. The method of claim 21, further comprising generating a notice when a change between the first and second differences is beyond a threshold limit.

23. The method of claim 19, further comprising:
receiving the packetized video data stream at the first site along the transmission path during a third time period that is after the first and second time periods;
performing the test on the packetized video data stream received during the third time period to generate a third test result; and
integrating the first, second, and third test results over time to generate an integral value.

24. The method of claim 23, further comprising generating a notice when integral value is beyond a threshold limit.
